(19) United States
(12) Patent Application Publication
(10) Pub. No.: US 2008/0193615 A1
(43) Pub. Date: Aug. 14, 2008

(54) LOW FAT CONSUMER PRODUCT COMPRISING A NATURAL PRESERVATIVE SYSTEM AND A METHOD FOR MAKING THE SAME

(75) Inventors: Michael Charles CIRIGLIANO, Cresskill, NJ (US); Bernard Charles SEKULA, Glen Gardner, NJ (US); Donald Joseph HAMM, New Providence, NJ (US); Laura Anne GALLAGAN, Franklin Park, NJ (US)

Correspondence Address: UNILEVER PATENT GROUP, 800 SYLVAN AVENUE, AG West S. Wing, ENGLEWOOD CLIFFS, NJ, 07632-3100, US

(73) Assignee: Conopco, Inc., d/b/a UNILEVER, Englewood Cliffs, NJ (US)

(21) Appl. No.: 11/673,717

(22) Filed: Feb. 12, 2007

(51) Int. Cl. A23L 3/3544; A23B 5/14; A23C 3/08

(52) U.S. Cl. 426/330.1; 426/330; 426/330.2

(57) ABSTRACT

Low oil or fat consumer food products comprising a natural preservative system and method are disclosed. The preservative system has a mixture of aliphatic and aromatic isothiocyanates and is suitable for use in a variety of consumer products with staged refrigeration, as well as temperature cycling to achieve a low fat consumer food product that is microbiologically stable and safe while lacking undesirable mustard flavor and/or burn.

### FIELD OF THE INVENTION

The present invention is directed to a low fat or oil consumer product comprising a natural preservative system and a method for making the same. More particularly, the present invention is directed to method of rendering a low fat or oil consumer product microbiologically stable and safe by subjecting a composition comprising a natural preservative system recovered from, for example, mustard seeds, to staged refrigeration and/or temperature cycling.

### BACKGROUND OF THE INVENTION

Standard preservative systems are known to dramatically alter the flavor characteristics of food compositions, rendering the same safe but lacking or unacceptable to consumers from a taste and/or performance standpoint. Low fat or oil spoonable dressings of the mayonnaise type are especially difficult to stabilize when a natural or organic product is desired. As is well known in the food processing art, the greater the amount of water in a composition, the more difficult it is to stabilize microbiologically.

It is of increasing interest to develop a consumer product comprising a natural preservative system that may be used in home and personal care compositions and food and beverage products, and especially, food products that contain an oil-in-water emulsion, such as low-fat or oil spoonable mayonnaise type dressings. This invention, therefore, is directed to a consumer product comprising a natural preservative system and a method for making and preserving the consumer product. The natural preservative system comprises components derived from, for example, mustard seeds. In a preferred embodiment, the natural preservative system comprises a mixture of isothiocyanates, and surprisingly, is suitable for use in a variety of consumer products without having a negative impact on flavor and product performance characteristics. Aliphatic isothiocyanates are barely water soluble and, therefore, there is a limit as to how much aliphatic isothiocyanate will be effective as the water level is increased and the oil level is decreased in low fat consumer products. Also, as the oil level is reduced in a consumer food product, aliphatic isothicyanates contribute to an increasingly strong mustard flavor or burn. Aromatic isothiocyanates may be used, but they hydrolyze at a rate that is about ten-fold as compared with that of aliphatic isothiocyanates.

The isothiocyanates in their unhydrolyzed form have a very strong mustard flavor and/or heat. Aromatic isothiocyanates, such as 4-HBITC, are particularly unstable in aqueous solutions at ambient temperatures and will, for the most part, break down into their hydrolysis byproducts within about 8 to about 24 hours. The hydrolysis reaction proceeds at a much slower rate at refrigerated temperatures and at lower pHs.

Therefore, it would be an advantage to use a natural preservative system and preservation method that allows the reduction or elimination of chemical preservatives while making a microbiologically stable low fat or oil consumer food product that is also significantly organoleptically acceptable. According to the present invention, a method for rendering a consumer product microbiologically stable and safe is provided for a low fat or oil consumer food product with more than about 75 ppm isothiocyanate, based on total concentration of the consumer product, and preferably, comprising a mixture of isothiocyanates comprising aliphatic and aromatic isothiocyanates at a concentration ratio from 1:3 to 1:300. The low fat or oil consumer food products are organoleptically acceptable and do not have an appreciable taste or burn of mustard.

### Additional Information

Antimicrobial effects of allyl, benzyl and ethyl isothiocyanates are discussed in FSTA Abstract XP-002390678. Efforts have been disclosed for making preservative systems. In Ekanayake et al., U.S. Pat. Nos. 7,105,190, 6,361,812 and 6,558,723, products that may be made with less than about 75 ppm of isothiocyanate compounds and at least one of a sorbate and benzoate are described. U.S. Patent Application No. 2005/0079255 discloses a composition for preserving solid food products comprising a moisture-sensitive isothiocyanate (degradable via a hydrolysis reaction) and a hygroscopic carrier, wherein the composition is substantially free of sorbic acid, benzoic acid, and salts thereof.

Further efforts have been disclosed in U.S. Published Application US2006/0286045 for a natural preservative system wherein preferably present within the natural preservative system are at least one aliphatic isothiocyanate and at least one aromatic isothiocyanate at a concentration ratio from 1:2 to 1:25 and further wherein the natural preservative system makes up more than about 75 ppm of the total concentration of a consumer product such as full fat mayonnaise.

None of the additional information describes a low fat consumer product with a natural preservative system and a method for making the consumer product wherein preferably present within the natural preservative system are at least one aliphatic isothiocyanate and at least one aromatic isothiocyanate at a concentration ratio from 1:3 to 1:300 and further wherein the natural preservative system makes up more than about 75 ppm of the total concentration of the consumer product, and wherein the effects of the preservative system are maximized with staged refrigeration and/or temperature cycling during storage while avoiding mustard flavor and/or heat or burn.

### SUMMARY OF THE INVENTION

The preservation method according to the present invention is designed to ameliorate the microstability versus flavor balance problems of the prior art and includes a staged refrigeration of a product that is normally stored at ambient temperature, as well as cycled refrigeration or cooling. The method and system of the present invention are directed to low fat or oil food products that require microbial stability for a relatively long shelf life time, i.e. preventing spoilage and the outgrowth of pathogenic microbes.

In a first aspect, the present invention is directed to a microbiologically stable low fat or oil consumer food product including:

(a) an aliphatic isothiocyanate;

(b) an aromatic isothiocyanate; and

(c) less than about 65% oil, preferably about 25% to about 65% oil, wherein the aliphatic and aromatic isothiocyanates are present at a concentration ratio about 1:3 to about 1:300, preferably about 1:3 to about 1:30, respectively, and make up collectively, more than about 75 ppm of the total concentration of the consumer product, preferably about 80 to about 400 ppm; and most preferably, about 100 ppm to about 200 ppm, including all ranges subsumed therein; where the low fat or oil consumer product is free of a mustard-like aftertaste and/or heat or burn. The consumer product may include a filling, dip, sauce, spread, topping, dressing, or dairy-based product. The consumer product is ambient stable microbiologically subsequent to its preparation, packaging, and an initial cooling stage prior to its return to the ambient temperatures at which similar food products, such as dressings products, are usually stored. In a further embodiment, a consumer product may be cooled subsequent to manufacture and packaging at a temperature of about 5 to about 7 deg. C. for a period of time sufficient to achieve microbial kill, followed by cycling the temperature from about 5 to about 7 deg. C. up to from about 10 to about 15 deg. C. to about ambient temperature in order to allow the composition to degrade the isothiocyanate preservative so as to avoid mustard flavor or burn, followed by cycling the temperature back down to about 5 deg. C. to about 10 deg. C. Note, a fine balance must be achieved in stabilizing these consumer food products without deleteriously affecting their flavor.

In a second aspect, a method for making the microbiologically ambient stable low fat or oil consumer food product of the first aspect of this invention, employs a preservative system of aliphatic and aromatic isothiocyanates at a concentration ratio of about 1:3 to about 1:300, preferably about 1:3 to about 1:30, with the isothiocyanates making up more than 75 ppm of the total concentration of the consumer food product. The method includes staged refrigeration of the product which is normally stored at ambient temperature prior to opening. The staged refrigeration or chilling is for a period of about 8 hours to about 1 week at a temperature of about 5 deg. C. to about 7 deg. C. A microbiologically stable consumer food product is recovered, i.e., not subject to yeast, mold, bacterial spoilage, or pathogen contamination. The consumer food product may subsequently be stored at ambient temperature at a continued stable and safe state for a period of about 24 hours to avoid mustard flavor or burn. The temperature is then cycled back down to about 5 deg. C. to about 10 deg. C. to obtain a microbiologically stable consumer food product for a further period preferably at least about 45 days, and as long as at least about 3 months.

In a further aspect of the present invention, the inventive method and preservative system does not require heat treatment in order to achieve microbial stability. Preferably, the preservation system and method according to the present invention takes place in the absence of additional preservatives, especially chemical preservatives, thereby resulting in a natural consumer food product.

Food products, as used herein, mean edible products including a filling, dip, sauce, spread, topping, dressing (including light and low fat mayonnaise type products), dairy-based products (including beverages), meat-based products, soups, and batters. Low fat mayonnaise type products are preferred because they benefit most from the preservative system of the present invention.

Dressings, as used herein, are meant to include oil-in-water emulsions and double emulsions, and especially, low fat or light mayonnaise type dressings having less than about 65% oil or fat.

Ambient stable refers to products that do not require refrigeration prior to opening when stored in a package at temperature of about 20 deg. C. to about 30 deg. C., preferably about 25 deg. C., and is meant to denote environmentally naturally occurring temperature in a relatively temperate climate, such as, for example, that which is usually referred to as room temperature.

Microbiologically stable (i.e., spoilage free) means no outgrowth of spoilage bacteria, yeast and/or mold and no flavor loss attributable to micro-organism activity for a desired shelf life of a product, preferably at least 45 days, and more preferably at least three (3) months, before opening a package storing the same at a pH of less than 4.75, and at least one (1) month, and preferably, for up to and at least one and one-half (1½) months before opening and when kept at 10° C. and at a pH of less than 5.5, and preferably at a pH of about 3.6 to about 5.0.

Microbiologically safe means compliant with national food regulations and codes by agencies, such as the US Food and Drug Administration (ref. the 2005 Food Code), such that the food is not a potentially hazardous food, or the USDA FSIS's Listeria monocytogenes pathogen control program (ref. the FSIS 2003 Interim Final Rule for Ready-to-Eat Meat and Poultry Products). Microbiologically safe (for products kept at about 25° C. and 50° C.) means preventing the outgrowth of pathogens and/or achieving and maintaining at least about a 2 log die off of pathogens (like Listeria monocytogenes) for the desired shelf-life of the product, when kept at a pH from about 3.0 to less than about 5.5.

Aromatic isothiocyanate means having a ring with lower pi-election energy from the open chain of the ring and having the group —N═C═S.

Aliphatic isothiocyanate means not having an aromatic group and having the group —N═C═S.

As used herein, “ppm” represents “parts per million,” in accordance with its common usage.

Substantially free means less than 0.0001% by weight based on total weight of the consumer product.

Recovered, as used herein, means obtained by generating or extracting from a plant or seeds or flowers (like a plant in the cruciferae species or the seeds or flowers thereof) in isolated form, in a mixture of components, plated on a carrier like a salt or carbohydrate, in oil or as a component of an oil, all of which may be the result of reactions with myrosinase. The plants contain the enzyme myrosinase which, in the presence of water cleaves off the glucose group from a glucosinolate. The remaining molecule then quickly converts to a thiocyanate, an isothiocyanate or a nitrile; these are the active substances that serve as defense for the plant. To prevent damage to the plant itself the myrosinase and glucosinolates are stored in separate compartments of the cell and come together only under conditions of stress or injury.

Staged chilling, cooling or refrigeration, as used interchangeably herein, means storage of a finished product at a temperature of about 5 deg. C. to about 10 deg. C. for about 8 hours to about 1 week, followed by return to the usual storage at ambient temperature.

Natural means occurring or produced in nature or synthesized to replicate or be a derivative of a component found in nature. Organic as it refers to products according to the present invention relates to obviating the use of chemical preservatives, such as sorbic acid and benzoic acid, and chemical sequestrants, such as EDTA.

Free of thermal processing means in the absence of hot filling, retorting and pasteurization steps.

### DETAILED DESCRIPTION OF THE INVENTION

The present invention achieves a unique balance between rendering microstability and avoiding a mustard flavor or burn in a consumer product, particularly, low fat food product. Use of too much aliphatic isothiocyanate, such as allyl isothiocyanate, will result in too strong a mustard flavor and/or heat or burn in the product. Use of too much AITC becomes more of an issue as the relative amount of oil is reduced and the relative amount of aqueous phase is correspondingly increased. As the water content increases, more AITC partitions into the water, causing a strong mustard flavor, burn or heat which are undesirable and lasting for as long as six to eight months of storage. At the same time, a certain minimum amount of preservative is needed. Therefore, aromatic isothiocyanate, such as 4-hydroxyisothiocyanate is included such that the concentration ratio of aliphatic isothiocyanate to aromatic ITC is about 1:3 to about 1:300, preferably about 1:3 to about 1:30. This ratio is important because the aliphatic and aromatic ITC's are subject to degradation by hydrolysis reaction in the aqueous phase, although at different rates. The aromatic ITC, such as 4-HBITC, hydrolyzes faster. Also, the rate of hydrolysis increases with increased temperature and pH. Without wishing to be bound by theory, Applicants believe that the inventive staged cooling of finished product achieves microbiological stability and minimizes mustard flavor, heat or burn with subsequent ambient storage. The aromatic ITC achieves microbial kill during the cooling stage starting immediately after packaging, followed by its degradation upon returning to ambient temperature, thereby minimizing mustard flavor, burn or heat. The aliphatic ITC supplies a continuous but gradual release into the aqueous phase where it controls any further outgrowth of microbes.

In a further embodiment, a consumer product may be cooled subsequent to manufacture and packaging at a temperature of about 5 to about 7 deg. C. for a period of time sufficient to achieve microbial kill, followed by cycling the temperature from about 5 to about 7 deg. C. up to from about 10 deg. C. to about ambient temperature in order to allow the composition to degrade the isothiocyanate preservative so as to avoid mustard flavor or burn, followed by cycling the temperature back down to about 5 deg. C. to about 10 deg. C.

The term “comprising” is used herein in its ordinary meaning and means including, made up of, composed of, consisting and/or consisting essentially of. In other words, the term is defined as not being exhaustive of the steps, components, ingredients, or features to which it refers.

Except in the operating and comparative examples, or where otherwise explicitly indicated, all numbers in this description indicating amounts or ratios of material or conditions of reaction, physical properties of materials and/or use are to be understood as modified by the word “about”.

There is no limitation with respect to the source of the isothiocyanates used in this invention, and it is within the scope of this invention to employ naturally found and synthetically made isothiocyanates that are replicates or derivatives of those found in nature.

In a preferred embodiment, the isothiocyanates are recovered from sources like broccoli, horseradish, mustard, turnip, cabbage, brussel sprouts, kale, collards, cauliflower, cole crops, rutabaga, watercress, radish, nasturtium, spinach, charlock, rapeseed, wasabi, combinations thereof or the like. A preferred source of the isothiocyanates is mustard, more preferably, white mustard.

Illustrative examples of the types of isothiocyanates suitable for use in this invention include allyl isothiocyanate, 3-butenyl isothiocyanate, benzyl isothiocyanate, 2-butyl isothiocyanate, 4-hydroxybenzyl isothiocyanate or p-hydroxybenzyl isothiocyanate, methyl isothiocyanate, 4-methylthio-3-butenyl isothiocyanate, 4-pentyl isothiocyanate, 2-phenylethyl isothiocyanate, phenyl isothiocyanate, 6-methylsulfinyl hexyl isothiocyanate, 3-methylsulfinyl propyl isothiocyanate, 4-methoxy-3-indolymethyl isothiocyanate, 1-methoxy-3-indolymethyl isothiocyanate, 3-indolylmethyl isothiocyanate, 5-methylthiopentyl isothiocyanate, 2-hydroxy-4-pentenyl isothiocyanate, 4-methylpentyl isothiocyanate, sec-butyl isothiocyanate, 2-hydroxy-3-butenyl isothiocyanate, 3-methylthioalkyl isothiocyanate, mixtures thereof or the like.

In a preferred embodiment, the aliphatic isothiocyanate that is used in this invention is allyl isothiocyanate and the preferred aromatic isothiocyanate is p-hydroxybenzyl isothiocyanate (para-hydroxy benzyl isothiocyanate). In a more preferred embodiment, the mixture of isothiocyanates comprises aliphatic isothiocyanate and aromatic isothiocyanate at a concentration ratio from about 1:3 to about 1:300, preferably about 1:3 to about 1:30, including all ranges subsumed therein. In yet another more preferred embodiment, the concentration of isothiocyanate (collectively) in the product is from 80 ppm to 400 ppm, and most preferably, about 100 ppm to about 200 ppm, including all ranges subsumed therein.

The natural preservative system of this invention can be combined with consumer product ingredients to make a product like a food product or combined with product that has already been prepared whereby combined is meant to optionally include marinating. The process requires a cooling step during and/or after combination of the preservative system with other ingredients for a time sufficient to achieve microbial kill. Subsequent to the microbial kill, it is advantageous to store the consumer product at its usual ambient storage temperature. Surprisingly, when using the preservative system according to the method of this invention, a product like a filling, dip, sauce, spread, dressing, beverage or the like, is rendered microbiologically safe even when no or substantially no additional and traditional preservative (e.g., sorbate and/or benzoate) is used. Moreover, the products of this invention, when food products, are unexpectedly, free of a mustard-like aftertaste or heat that is associated with mustard ingredients.

When making the food composition of the present invention, the ingredients (e.g., insoluble fiber, fiber and flavor base) may be added, in no particular order, to a mixing vessel and stirred under moderate shear (typically at ambient temperature and atmospheric pressure) to produce a homogeneous mixture. Also, the homogeneous mixture can optionally be milled in order to reduce particle sizes and/or optionally de-aerated. The homogeneous mixture is, however, preferably homogenized to produce the desired food composition of this invention.

The products of this invention, when food products, typically have a pH below about 5.5, and preferably, from about 3.5 to about 5.5, and preferably, for mayonnaise type dressings from about 3.6 to about 4.5, including all ranges subsumed therein. Such food products are preferably low fat or oil products, and can optionally comprise vegetables (including chunks and puree), protein, wheat, sweeteners (including sugar and artificial sweeteners), oil, emulsions, fruit (including chunks and puree), cheese, mixtures thereof.

Illustrative and non-limiting examples of preferred low fat food products prepared with the natural preservative system of this invention include water-in-oil and oil-in-water based spreads and toppings, pourable dressings; fruit-based compositions; dressings like those of the mayonnaise type. In a preferred embodiment, the low fat food product made with the natural preservative system of this invention is a low fat or light mayonnaise comprising less than about 65% by weight oil, and most preferably, from about 25% to about 65% by weight oil. In an especially preferred embodiment, the food product is low fat or light mayonnaise type emulsion comprising about 25% to about 45% by weight oil based on total weight of the food product and including all ranges subsumed therein.

The oil suitable for use in the food composition is often a liquid at ambient temperature and can be an oil like avocado, mustard, coconut, cottonseed, fish, flaxseed, grape, olive, palm, peanut, rapeseed, safflower, sesame, soybean, sunflower, mixtures thereof or the like. Other types of oils which may be used in this invention are solid at ambient temperature. Illustrative examples of the oils which are solid at room temperature and suitable for optional use in this invention include, without limitation, butter fat, chocolate fat, chicken fat, mixtures thereof and the like.

When an oil-in-water emulsion is desired, conventional emulsifiers, like the food suitable emulsifiers having an HLB of greater than about 8.0 to about 18.0 can be used, i.e. oil-in-water emulsifiers. Illustrative examples of the emulsifier suitable for use in this invention include, without limitation, PEG 20 tristearate, PEG 20 trioleate, PEG 20 monostearate, PEG 20 monooleate, PEG 20 monopalmitate and PEG 20 monolaurate sorbitan, derivatives thereof, mixtures thereof and the like, also made available by ICI Surfactants under the names Tween or Span. The preferred emulsifier employable in this invention is, however, a protein, like fruit, vegetable, milk (e.g., whey), egg yolk, soy protein, or mixtures thereof. Another preferred protein suitable for use in this invention is phospholipoprotein, and especially, egg yolk derived phospholipoprotein modified with phospholipase A as disclosed in U.S. Pat. No. 5,028,447. If used, the emulsifier often makes up from about 0.1 to about 10.0% by weight of the total weight of the food composition, based on total weight of the food composition and including all ranges subsumed therein.

Optional Ingredients

The food product of this invention can optionally comprise soluble fibers, insoluble fibers (like citrus fibers), gums (like xanthan), starches, cellulose, vitamins, buffers, antioxidants, preservatives (like sorbates and benzoates, lauramide of arginine monohydrochloride (LAE or lauric arginate), nisin, natamycin and other natural bacterial fermentates having antimicrobial effect, benzoic acid, derivatives thereof, salts thereof, mixtures thereof), acidulants (including organic and inorganic acids), colorants, emulsifiers, alcohol, spices (including salt), syrups, milk, food grade dispersants or stabilizers (like propylene glycol alginate), solubilizing agents (like propylene glycol), milk powder or mixtures thereof.

Insoluble fiber for use in the present invention is fiber suitable for human consumption and not water soluble whereby the same is provided as an additive to the food composition. Soluble fiber is a fiber suitable for human consumption and water soluble whereby the same is an additive to the food composition. Neither the insoluble fiber nor the soluble fiber is meant to include the fibers normally supplied in the flavor base. Flavor base means the base of the food composition that is responsible for the identification of the composition.

The insoluble fibers typically used in this invention are found, for example, in fruits, both citrus and non-citrus. Other sources of the insoluble fibers suitable for use in this invention are vegetables like legumes, and grains. Preferred insoluble fibers suitable for use in this invention can be recovered from tomatoes, peaches, pears, apples, plums, lemons, limes, oranges, grapefruits or mixtures thereof. Other preferred insoluble fibers suitable for use in this invention may be recovered from the hull fibers of peas, oats, barley, soy, or mixtures thereof. Still other fibers which may be employed include those that are plant or root-derived as well as those which are wood-derived. Typically, the food composition of this invention comprises from about 0.05 to about 3.0%, and preferably, from about 0.15 to about 2.0%, and most preferably, from about 0.2 to about 0.75% by weight insoluble fibers, based on total weight of the food composition, and including all ranges subsumed therein. Such insoluble fibers are commercially available from suppliers like J. Rettenmaier and Sohne GMBH under the Vitacel name and Herbstreith & Fox under the Herbacel name. These insoluble fibers typically have (as supplied) lengths from about 25 to about 400 microns, and preferably, from about 50 to 185 microns, and most preferably, from about 100 to about 165 microns, including all ranges subsumed therein. The widths of such fibers are typically between about 3.0 to about 20.0 microns, and preferably, from about 5.0 to about 10.0 microns.

The soluble fibers suitable for optional, yet often preferred, use in this invention include those generally classified as thickening agents or gums. Illustrative examples of the types of gums suitable for use in this invention include xanthan gum, pectin, locust bean gum, guar gum, gellan gum, gum ghatti, modified gum ghatti, tragacanth gum, carrageenan, acacia, as well as mixtures thereof. Thickening agents derived from cellulose may also be employed and they include methylcellulose, carboxymethylcellulose, sodium carboxymethylcellulose, hemi-cellulose, and mixtures of these polymers, either alone or in combination with the above-identified gums. Typically, when soluble fibers are used, such fibers make up from about 0.05 to about 1.0%, and preferably, from about 0.1 to about 0.75%, and most preferably, from about 0.125 to about 0.35% by weight of the total weight of the food composition, including all ranges subsumed therein. There is no limitation with respect to the size (i.e., dimensions) of the soluble fibers other than that they are a size suitable for food compositions made for human consumption. Typically, however, the soluble fibers are of a size that is substantially similar to the size of the insoluble fibers.

In a preferred embodiment, and when soluble fibers are used, the weight ratio of insoluble to soluble fibers used in the food composition is from about 1:1 to about 4:1. In a more preferred embodiment, the weight percent of insoluble fibers is from about 1.25 to about 3.5 times, and most preferably, from about 1.5 to about 3.0 times greater than the weight percent of soluble fibers used in the food composition, based on total weight of the food composition and including all ranges subsumed therein.

Further, optionally, the food product of this invention comprises about 30% by weight meat, and most preferably, from about 45 to about 65% by weight meat and from 0.0 to 15% by weight solid particulate like vegetables and/or fruit.

Packaging

The packaging suitable for use with the food products made according to this invention is often a glass jar, food grade sachet, a plastic tub or squeezable plastic bottle. Sachets are preferred for food service applications, a tub is preferred for spreads and protein based salads, and a squeezable plastic bottle is often preferred for non-spreads and domestic use.

The following examples are provided to illustrate an understanding of the present invention. The examples are not intended to limit the scope of the claims.

### EXAMPLES

A white mustard extract containing “4-HBITC” was obtained from Newlyweds Foods, Chicago, Ill., under the brand name IsoGard™. Volatile Oil Mustard (VOM) containing AITC was sourced as a dilution of AITC in vegetable oil from International Flavors and Fragrances located in New Jersey.

The VOM level used in each test was held constant to deliver approximately 30 ppm AITC. Two white mustard extract levels were evaluated, i.e. 1% dilution in canola oil (equivalent to 100 ppm 4-HBITC) and 2% dilution in canola oil (equivalent to 200 ppm 4-HBITC).

Efficacy of AITC and 4-HBITC in low fat mayonnaise as a fungicide (APRY yeast) and/or as a bactericide (Lactic Acid Bacteria—LAB) was evaluated at a pH of 3.22 using the Base Formula in the Table below alone and with HBITC.

TABLE 1
Base Formula

| INGREDIENT | % |
|---|---|
| Volatile oil of Mustard | 0.0003 |
| (30 ppm AITC) | |
| IsoGard ™ VO | 0.0000 |
| (200 ppmHBITC) | |
| Soybean Oil | 20.0000 |
| Vinegar 12% | 0.8000 |
| Liquid Egg Yolk 10% Salt | 1.0000 |
| Liquid Whole egg 10% Salt | 3.0000 |
| Salt | 1.6000 |
| Xanthan Gum | 0.2000 |
| Ultra Tex 4 | 6.0000 |
| Vinegar 12% | 1.2000 |
| Citric Acid | 0.1200 |
| Sugar (Sucrose) | 3.0000 |
| Water (Balance)* | 63.0797 |

*Water was balanced to 100% with and without addition of HBITC

### EXAMPLE 1

### Condition A—No Refrigeration

This example demonstrates the effect of a low level of AITC alone in the Base Formula above at ambient temperature.

Low fat mayonnaise compositions having about 30 ppm allyl isothiocyanate were made. No aromatic isothiocyanate was incorporated. Stability studies of the same demonstrated that subsequent to both the high and the low lactic acid bacteria inoculation counts introduced being reduced to non-detectable levels by week 2, a two log increase in lactic acid bacteria counts occurred in the high inoculum sample between weeks 8 and 12 at ambient temperature. The high and low yeast inoculated samples spoiled within 2 weeks reaching yeast count levels in the 10⁶ log at week 2. The initial low and high inocula were 100 and 10,000 cfu/gram, respectively.

### EXAMPLE 2

### Condition A—No Refrigeration

This example demonstrates the effect of a low level of AITC with HBITC at ambient temperature.

Low fat mayonnaise compositions (200 ppm HBITC added to the formula in the table above) having about 30 ppm allyl isothiocyanate and about 200 ppm HBITC (aromatic isothiocyanate) were made. Microbiological stability studies of the same demonstrated that subsequent to the high and low lactic acid bacteria counts being reduced to non-detectable levels by week 2, no increase in lactic acid bacteria counts was observed through week 12 of the study. As in Example 1, however, the high and low yeast inoculated samples spoiled the dressing formula reaching yeast count levels in the 10⁶ log by week 4. The initial low and high inocula were 100 and 10,000 cfu/gram, respectively.

### EXAMPLE 3

### Condition B—Staged Refrigeration. AITC and 4-HBITC

This example demonstrates the effect of a low level of AITC in combination with 4-HBITC at staged refrigeration followed by storage at ambient temperature. The samples were refrigerated for 1 week after inoculation followed by ambient storage.

Low fat mayonnaise compositions similar to the ones described in Example 2 were made with about 30 ppm allyl isothiocyanate and about 200 ppm of 4-hydroxy-benzyl isothiocyanate used as preservatives. After initial refrigeration at 5 deg. C. for about 1 week, followed by an ambient stage, stability studies demonstrated that after about 12 weeks at ambient temperature, there was no yeast spoilage at the low inoculation level or lactic acid bacteria spoilage at the high or low inoculation levels. No yeast spoilage was observed in the high inoculation level through week 6. The initial low and high inocula were 100 and 10,000 cfu/gram, respectively.

Similar results were obtained at 100 ppm HBITC and 35 ppm AITC.

Surprisingly, low fat mayonnaise compositions made with the preservative systems and methods of the present invention were microbiologically stable, notwithstanding the fact that they were formulated with more water than conventional mayonnaise compositions.

The following observations were made regarding the experiments in Examples 1-3. There were some minor differences of note observed between the response curves obtained on the “Control” sample (Example 1), and the “Control” sample with 200 ppm 4-HBITC (Example 2), subjected to room temperature incubation immediately after inoculation. The high and low inoculum levels for APRY yeast on the Control reached 1×10̂6 cfu/ml of dressing at the 2 week point while the 4-HBITC containing sample took 4 weeks to reach the same level. The Control also showed a “Phoenix” effect (reappearance after apparent “die-off”) at the high Lactic Acid Bacteria inoculation level. The corresponding 4-HBITC containing sample did not. The 4-HBITC containing dressing stored under refrigeration for 1 week, prior to ambient incubation (Example 3), showed no significant increase (i.e. >1-2 logs) in APRY yeast count at the low inoculation level, or Lactic Acid Bacteria counts at either the low or the high inoculum levels, for the full 12 week term of the study. At the high APRY inoculation level, on the other hand, a significant increase (>1-2 logs) in yeast count numbers, over the initial inoculation level of 10̂4 cfu/ml, did occur but not until 6-8 weeks into the study. The APRY yeast outgrowth also did not reach 10̂6 until 10 weeks into the study.

Also, and surprisingly, a skilled group of about 10 panelists concluded that the reduced oil mayonnaise compositions formulated with the preservative system and method of staged cooling of this invention were free of a mustard-like aftertaste, even when the same are formulated to have a pH at 3.22.

While the present invention has been described herein with some specificity, and with reference to certain preferred embodiments thereof, those of ordinary skill in the art will recognize numerous variations, modifications and substitutions of that which has been described which can be made, and which are within the scope and spirit of the invention. It is intended that all of these modifications and variations be within the scope of the present invention as described and claimed herein, and that the inventions be limited only by the scope of the claims which follow, and that such claims be interpreted as broadly as is reasonable. Throughout this application, various publications have been cited. The entireties of each of these publications are hereby incorporated by reference herein.

What is claimed is:

1. A microbiologically stable low fat or oil consumer food product comprising:
(a) an aliphatic isothiocyanate;
(b) an aromatic isothiocyanate; and
(c) less than about 65% oil
wherein the aliphatic and aromatic isothiocyanates are present at a concentration ratio from about 1:3 to about 1:300, respectively; and
wherein the aliphatic and aromatic isothiocyanates make up collectively, more than about 75 ppm of the total concentration of the consumer product;
wherein said consumer product is microbiologically stable at ambient temperature storage subsequent to preparation, packaging, and initial cooling stage; and wherein the food product is free of a mustard-like aftertaste and heat.

2. The microbiologically stable consumer product according to claim 1, wherein the aliphatic and aromatic isothiocyanates, collectively, make up about 80 to about 400 ppm of the total concentration of the consumer product.

3. The microbiologically stable consumer product according to claim 1, wherein the aliphatic and aromatic isothiocyanates, collectively, make up about 100 to about 200 ppm of the total concentration of the consumer product.

4. The microbiologically stable consumer product according to claim 1, wherein the consumer product is a filling, dip, sauce, spread, topping, dressing, or dairy-based product.

5. The microbiologically stable consumer product according to claim 1, wherein the consumer product is low fat mayonnaise comprising about 25 to about 65% by weight oil.

6. The microbiologically stable consumer product according to claim 1, wherein the consumer product is a low fat mayonnaise comprising from 25% to 45% by weight oil.

7. The microbiologically stable consumer product according to claim 1, wherein the food product has a pH of less than 5.5.

8. The microbiologically stable consumer product according to claim 1, wherein the food product has substantially no additional preservative in addition to the aliphatic and aromatic isothiocyanates.

9. The microbiologically stable consumer product according to claim 1, wherein the food product demonstrates no yeast or bacteria outgrowth.

10. The microbiologically stable consumer product according to claim 1, wherein the aliphatic isothiocyanate is allyl isothiocyanate and the aromatic isothiocyanate is p-hydroxybenzyl isothiocyanate.

11. A method for making a microbiologically stable low fat or oil consumer food product of the type normally stored at ambient temperature comprising the steps of:
(a) contacting a mixture of aliphatic and aromatic isothiocyanates with ingredients to make a consumer food product or with a prepared consumer food product comprising less than 65% fat or oil;
wherein the aliphatic and aromatic isothiocyanates are present at a concentration ratio from about 1:3 to about 1:300, respectfully;
wherein the isothiocyanates, collectively, make up more than 75 ppm of the total concentration of the consumer food product;
(b) subjecting said consumer food product to a temperature of about 5 deg. C. to about 7 deg. C. for a period of time of about 8 hours to about 1 week;
(c) recovering a microbiologically stable consumer food product; and
(d) maintaining said microbiologically stable consumer food product at ambient temperature at a continued stable state for a period of at least about 45 days to at least about 3 months.

12. A method for making a microbiologically stable consumer product according to claim 11, wherein the consumer food product is not heat treated.

13. The method according to claim 11, wherein the refrigeration or cooling stage takes place for a period of about 8 hours to about one week.

14. The method according to claim 11, wherein the aliphatic isothiocyanate is allyl isothiocyanate and the aromatic isothiocyanate is p-hydroxybenzyl isothiocyanate.

15. A method for making a microbiologically stable low fat or oil consumer food product comprising the steps of:
(a) contacting a mixture of aliphatic and aromatic isothiocyanates with ingredients to make a consumer food product or with a prepared consumer food product comprising less than 65% fat or oil;
wherein the aliphatic and aromatic isothiocyanates are present at a concentration ratio from about 1:3 to about 1:300, respectfully;
wherein the isothiocyanates, collectively, make up more than 75 ppm of the total concentration of the consumer food product;
(b) subjecting said consumer food product to a temperature of about 5 deg. C. to about 7 deg. C. for a period of time of about 8 hours to about 1 week;
(c) recovering a microbiologically stable consumer food product; and
(d) cycling the temperature up and maintaining said microbiologically stable consumer food product at a temperature of about 10 deg. C. to about ambient temperature at a continued stable state for a period of about 24 hours, thereby avoiding a mustard flavor or burn;
(e) cycling the temperature back down to about 5 deg. C. to about 10 deg. C. to obtain a microbiologically stable consumer food product for a further period of at least about 45 days.

16. A microbiologically stable low fat or oil consumer food product consisting essentially of:
(a) an aliphatic isothiocyanate;
(b) an aromatic isothiocyanate;
(c) less than about 65% oil;
(d) water; and
(e) optionally, an emulsifier;
wherein the aliphatic and aromatic isothiocyanates are present at a concentration ratio from 1:3 to 1:300, respectively; and
wherein the aliphatic and aromatic isothiocyanates make up collectively, more than about 75 ppm of the total concentration of the consumer product;
wherein said low fat or oil food product is microbiologically stable at ambient temperature storage subsequent to preparation, packaging, and initial cooling stage; and
wherein the food product is free of a mustard-like aftertaste and heat.

17. The microbiologically stable consumer product according to claim 16, wherein said product is a food product having a pH of less than about 5.5.

18. The microbiologically stable consumer product according to claim 16, wherein said aliphatic and aromatic isothiocyanates, respectively, are selected from the group consisting of allyl isothiocyanate, 3-butenyl isothiocyanate, benzyl isothiocyanate, 2-butyl isothiocyanate, 4-hydroxybenzyl isothiocyanate or p-hydroxybenzyl isothiocyanate, methyl isothiocyanate, 4-methylthio-3-butenyl isothiocyanate, 4-pentyl isothiocyanate, 2-phenylethyl isothiocyanate, phenyl isothiocyanate, 6-methylsulfinylhexyl isothiocyanate, 3-methylsulfinylpropyl isothiocyanate, 4-methoxy-3-indolymethyl isothiocyanate, 1-methoxy-3-indolymethyl isothiocyanate, 3-indolylmethyl isothiocyanate, 5-methylthiopentyl isothiocyanate, 2-hydroxy-4-pentenyl isothiocyanate, 4-methylpentyl isothiocyanate, sec-butyl isothiocyanate, 2-hydroxy-3-butenyl isothiocyanate, 3-methylthioalkyl isothiocyanate, and mixtures thereof.

19. The microbiologically stable consumer product according to claim 16, wherein said aliphatic and aromatic isothiocyanates, respectively, are allyl isothiocyanate and p-hydroxybenzyl isothiocyanate.

20. The microbiologically stable consumer product according to claim 16, wherein said product is a mayonnaise type dressing.
